(19) United States
(12) Patent Application Publication
(10) Pub. No.: US 2022/0053062 A1
(43) Pub. Date: Feb. 17, 2022

(54) METHODS AND APPARATUS FOR DELIVERING A MESSAGE TO A MAT PROCESSING USER

(71) Applicant: Steve SUBAR, Chicago, IL (US)

(72) Inventor: Steve SUBAR, Chicago, IL (US)

(21) Appl. No.: 16/990,495

(22) Filed: Aug. 11, 2020

(51) Int. Cl. H04L 29/08; H04L 5/00; A63B 21/00

(52) U.S. Cl. CPC H04L 67/26; A63B 21/4037; H04L 5/0053

(57) ABSTRACT

Methods and apparatus for delivering a message to mat processing user are disclosed. The disclosed process determines a mat processing metric based on typical yoga frequency information and a recorded number of mat processings for a user. The disclosed process then selects a communication channel, dynamically generates message content, and selects a delivery time based on the mat processing metric, A/B testing and/or user demographics. The disclosed process then delivers the message content at the delivery time to the user via the selected communication.

The present disclosure relates in general to processing mats, and, in particular, to methods and apparatus for delivering a message to a mat processing user.

### BACKGROUND

Traditionally, users of exercise mats, such as yoga mats, clean and disinfect their mats manually. For example, after a yoga session, a participant may spray his/her mat with a cleaner and wipe the mat down with a towel. However, this method is cumbersome and often ineffective. Mat processing devices have been used to attempt to overcome these limitations of manual mat cleaning. However, current mat processing devices, and the associated methods of using these mat processing devices, lack certain improvements disclosed herein. For example, message delivery to mat processing users and mat processing device authorization are currently deficient.

### SUMMARY

Methods and apparatus for delivering a message to mat processing user are disclosed. The disclosed process determines a mat processing metric based on typical yoga frequency information and a recorded number of mat processings for a user. The disclosed process then selects a communication channel, dynamically generates message content, and selects a delivery time based on the mat processing metric, A/B testing and/or user demographics. The disclosed process then delivers the message content at the delivery time to the user via the selected communication.

### BRIEF DESCRIPTION OF THE DRAWINGS

FIG. 1 is a block diagram of certain elements of an example network communications system.

FIG. 2 is a block diagram of an example computing device.

FIG. 3 is a block diagram of an example mat processing device.

FIG. 4 is a flowchart of an example process for authorizing use of a mat processing device.

FIG. 5 is a flowchart of an example process for delivering a personalized message to a mat processing user at a certain time via a selected communication channel.

### DETAILED DESCRIPTION OF THE PREFERRED EMBODIMENTS

Briefly, methods and apparatus for delivering a message to a mat processing user and authorizing use of a mat processing device are disclosed. In one embodiment, the disclosed process determines a mat processing metric based on typical yoga frequency information and a recorded number of mat processings for a user. The disclosed process then selects a communication channel, dynamically generates message content, and selects a delivery time based on the mat processing metric, A/B testing and/or user demographics. The disclosed process then delivers the message content at the delivery time to the user via the selected communication.

In an embodiment, the disclosed process requests and receives a public customer identifier. (e.g., a phone number). If the public identifier is not on a “PIN required” list, the process authorizes a mat processing (e.g., clean and/or disinfect a yoga mat) despite payment not yet being confirmed and no private information being entered (e.g., no PIN yet). If the public customer identifier is recognized by the system, the process requests and receives a private customer identifier (e.g., a PIN), even though the mat processing has already been authorized. If the private identifier is associated with the public identifier, the customer's account is debited for the mat processing. If the private identifier does not correspond to the public identifier, and optionally an additional user confirmation attempt fails (e.g., text message confirmation), the public identifier is placed on the “PIN required” list, so subsequent attempts will not receive a “free” mat processing. If the public customer identifier is not recognized by the system, then the customer, who has already been authorized to receive a “free” mat processing, appears to be a new customer and is sent a welcome/registration link, where the user may be given and/or provide a PIN for subsequent use on mat processing devices.

In another embodiment, the disclosed process determines a mat processing metric based on typical yoga frequency information and a recorded number of mat processings for a user. The disclosed process then selects a communication channel, dynamically generates message content, and selects a delivery time based on the mat processing metric, A/B testing and/or user demographics. The disclosed process then delivers the message content at the delivery time to the user via the selected communication.

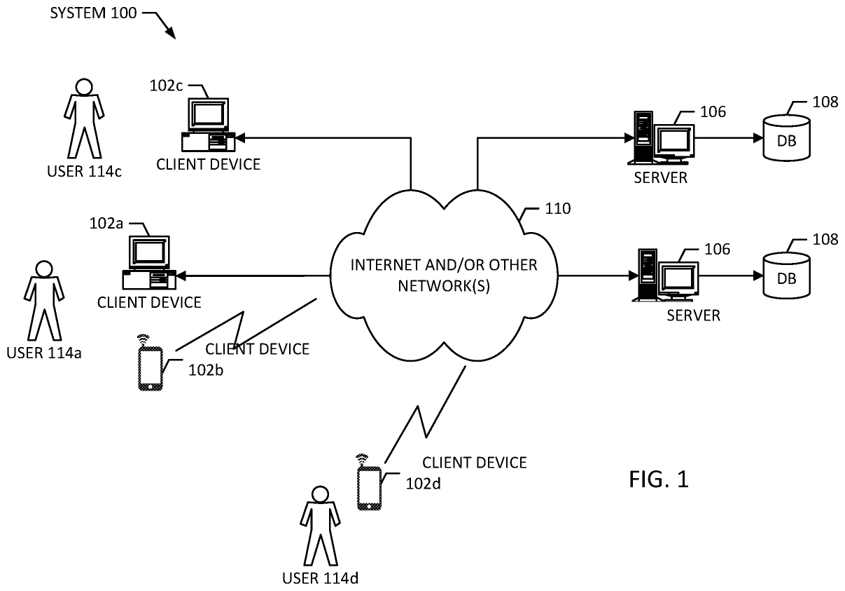

Turning now to the figures, the present system is most readily realized in a network communication system 100. A block diagram of certain elements of an example network communications system 100 is illustrated in FIG. 1. The illustrated system 100 includes one or more client devices 102 (e.g., mat processing device, computer, television, camera, phone), one or more web servers 106, and one or more databases 108. In one embodiment, the client device 102 includes a mat processing system, such as a yoga mat cleaning and disinfecting system. Each of these devices may communicate with each other via a connection to one or more communications channels 110 such as the Internet and/or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

In this example, user 114a is using client device 102a and client device 102b. For example, user 114a may be processing a mat, such as cleaning and/or disinfecting a yoga mat.

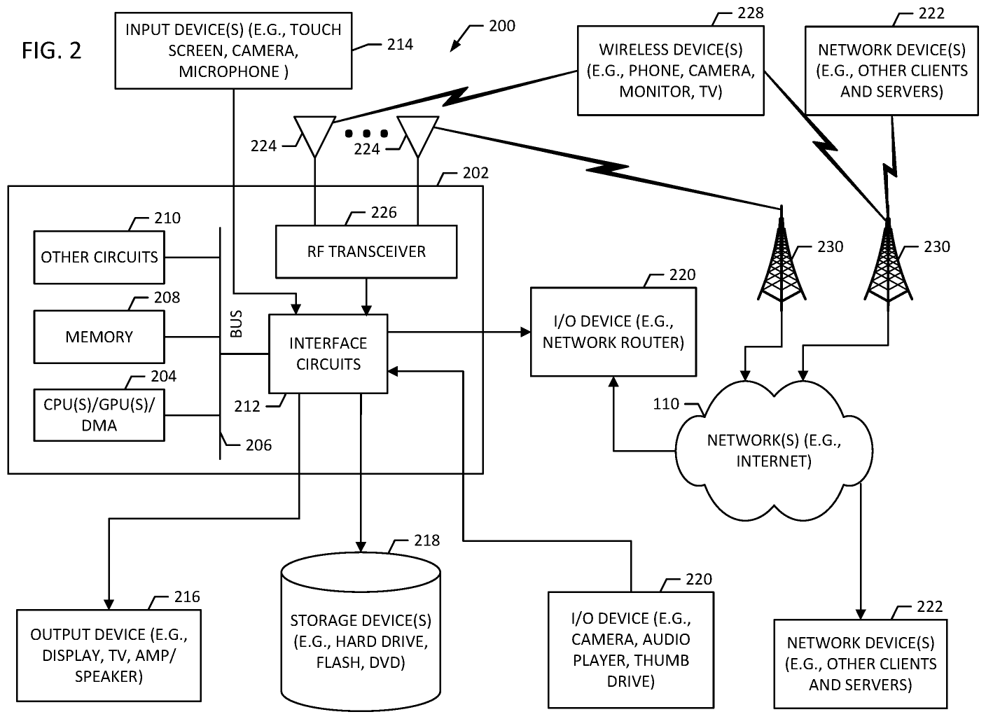

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device 200. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address), a password, and/or a personal; identification number (PIN), which may be required for the activation of services. The user identifier(s) and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

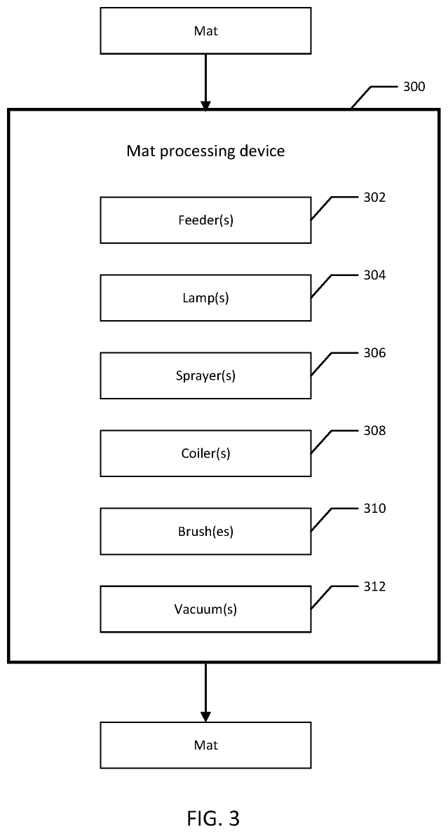

FIG. 3 is a block diagram of an example mat processing device 300. Some of the components of the mat processing device 300 may be implemented with some or all of the components of the example computing device 200. For example, the mat processing device 300 may include a panel such as a touch screen. In addition, other components may be included in the mat processing device 300. For example, safety switches may cease operation of some or all of the mat processing device 300 (e.g., UV lights) if a door is opened.

In this example, the mat processing device 300 includes a combination of operatively coupled devices including one or more feeders 302, one or more lamps 304, one or more sprayers 306, one or more colliers 308, one or more brushes 310, and/or one or more vacuums 312.

The feeders 302 guide each mat through the mat processing device 300. In one embodiment, the feeders 302 guide each mat through the mat processing device 300 from top to bottom (i.e., with gravity). The feeders 302 preferably include one or more stepper motors, controllers and sensors. The lamps 304 disinfect each mat. For example, the lamps 304 may be ultraviolet lamps. Light sensors may be used to assist in controlling the lamps 304. The sprayers 306 apply cleaner to each mat. Preferably, a reservoir and a reservoir sensor are connected to the sprayers 306. The colliers 308 coil each mat prior to retrieval from the mat processing device 300 by the user. The brushes 310 remove debris from the mats. In addition, the brushes 310 may assist in guiding the mats through the mat processing device 300. The vacuums 312 dry and/or remove debris from the mats. Preferably, the vacuums 312 include a pressure sensor to assist in controlling the vacuum.

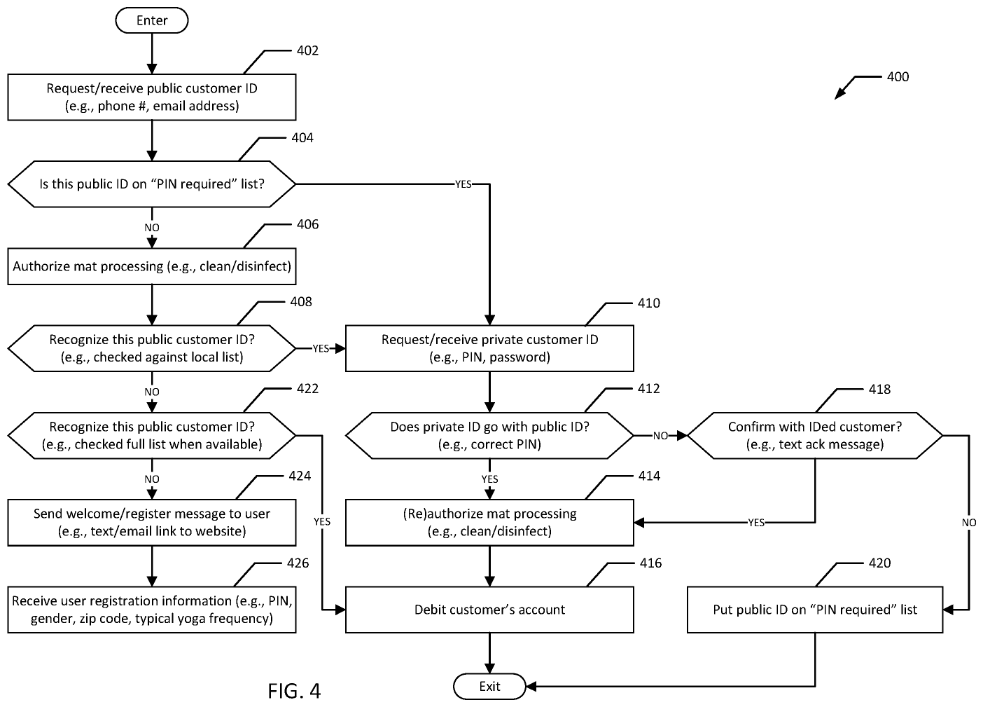

FIG. 4 is a flowchart of an example process 400 for processing mats. The process 400 may be carried out by one or more suitably programmed processors, such as a CPU executing software (e.g., block 204 of FIG. 2). The process 400 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 400 is described with reference to the flowchart illustrated in FIG. 4, it will be appreciated that many other methods of performing the acts associated with process 400 may be used. For example, the order of many of the operations may be changed, and some of the operations described may be optional.

In this example, the process 400 begins by requesting and receiving a public customer identifier. (block 402). For example, a user may enter a phone number and/or an email address. Subsequently, the process 400 determines if the public identifier is on a “PIN required” list (block 404). Although a personal identification number (PIN) is used throughout this description, a person of ordinary skill in the art will readily appreciate that any suitable identifier may be used. If the public identifier is not on a “PIN required” list, the process 400 authorizes a mat processing (block 406). For example, the mat processing device 300 may proceed to clean and/or disinfect the user's yoga mat, despite payment not yet being confirmed and no private information being entered (e.g., no PIN yet).

The process 400 also determines if the public customer identifier is recognized by the system (block 408). For example, the public customer identifier may be checked against a list of previously registered public customer identifiers stored locally in the mat processing device 300. Checking a local list does not require communication with a central/cloud device. In some embodiments, the customer identifier is compared to a list of known customer identifiers stored in a cloud environment and accessed remotely. In other embodiments, a subset (e.g., curated list) of known customer identifiers is downloaded to individual mat processing devices 300 based on local usage, and/or other factors, in order to reduce a need for communication with a remote source. If the public customer identifier is recognized by the system (block 408), the process 400 requests and receives a private customer identifier (block 410). For example, the user may enter a PIN and/or a password. Similarly, the user may be recognized with fingerprint recognition, facial recognition, and/or any other suitable recognition means.

If the private identifier is associated with the public identifier (block 412), the process 400 authorizes mat processing (block 414). For example, if the entered phone number is associated with the entered PIN, then the mat processing device 300 may proceed to clean and/or disinfect the user's yoga mat. In the event that mat processing was already authorized in block 406, reauthorizing may have no material effect. However, if the public identifier is on a “PIN required” list (block 404), then successful PIN entry may be needed to effectuate mat processing. In either case, the customer has been properly identified by both his/her public and private identifiers, and the customer's account is debited for the mat processing (block 416).

If the private identifier does not match the public identifier (block 412), confirmation of the use of the public identifier is attempted with the user (block 418). For example, the user may be sent a text message at the user's phone number. Alternatively, or in addition, the user may be sent an email message for usage confirmation. If the user confirms that he/she was the user (e.g., via return text message), the process 400 authorizes mat processing (block 414). However, if user confirmation is not achieved, the public identifier is placed on a “PIN required” list (block 420). Of course, a person of ordinary skill in the art will readily appreciate that users may be given multiple attempts to enter a PIN and/or confirm usage before being placed on a “PIN required” list.

If the public customer identifier is not recognized by the system locally (block 408), the process 400 determines if the public customer identifier is recognized by the system centrally (block 422). For example, the public customer identifier may be checked against a global list of previously registered public customer identifiers in a central location (e.g., an internet server). If the public customer identifier is recognized by the system (block 422), then the customer has been properly identified by both his/her public and private identifiers, and the customer's account is debited for the mat processing (block 416).

However, if the public customer identifier is not recognized by the system (block 422), then the customer appears to be a new customer and is sent a welcome/registration message (block 424). For example, the new user may be sent a text message to the entered phone number and/or an email message to the entered email address. The welcome/registration message preferably includes a link to a welcome/registration website. At the welcome/registration website, the user may provide his/her registration information (block 426). For example, the user may be given and/or choose a PIN for subsequent use on mat processing devices 300. In addition, the user may provide demographic information, such as gender and zip code. Further, the user may provide processing metric information, such as his/her typical yoga frequency.

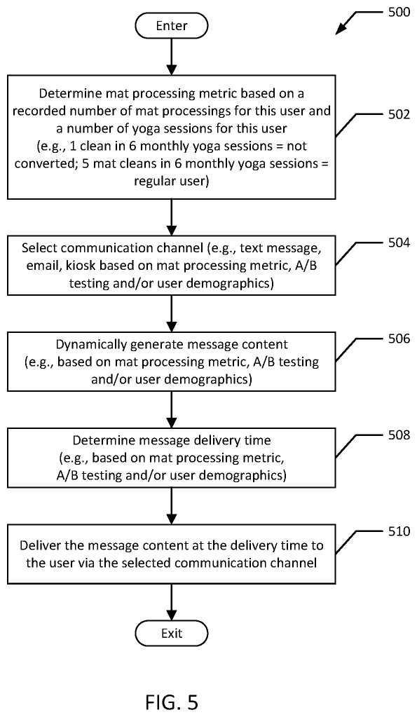

FIG. 5 is a flowchart of an example process 500 for delivering a personalized message to a mat processing user at a certain time via a selected communication channel. The process 500 may be carried out by one or more suitably programmed processors, such as a CPU executing software (e.g., block 204 of FIG. 2). The process 500 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In this example, the process 500 begins by determining a mat processing metric based on typical yoga frequency information and a recorded number of mat processings for the user (block 502). For example, if the user has used the mat processing device 300 one time in six monthly yoga sessions, a “not converted” message content may be selected. However, if the user has used the mat processing device five times in six monthly yoga sessions, a “regular user” message content may be selected. The typical number of yoga sessions may determined in any suitable manner. For example, the typical number of yoga sessions may be entered by the user, entered by a yoga studio or other facilitator of the mat processing device 300, and/or determined by the mat processing device 300.

The process 500 also selects a communication channel based (block 504). For example, the selected communication channel may be text messaging, email, and or a user kiosk device, such as the mat processing device 300. The selection may be based on A/B testing, user demographics, and/or any other suitable selection criteria. The process 500 also dynamically generates message content (block 506). For example, the message content may be based on the mat processing metric, A/B testing, and/or user demographics. The process 500 also determines a delivery time (block 508). The delivery time may be based on the mat processing metric, A/B testing, user demographics, and/or any suitable means. For example, if a user regularly cleans his/her mat shortly after 7:00 AM, the process 500 may assume that this user attends a 6:00 AM class. Accordingly, a suitable message delivery time may be 5:30 AM (right before class). The process 500 then delivers the message content at the delivery time to the user via the selected communication channel (block 510).

In summary, persons of ordinary skill in the art will readily appreciate that methods and apparatus for delivering a message to a mat processing user have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of delivering a message to a mat processing user, the method comprising:
determining a mat processing metric based on a recorded number of mat processings for a user;
selecting a communication channel based on data associated with the user;
dynamically generating a message content based on the mat processing metric;
determine a message delivery time based on the mat processing metric; and
delivering the determined message content at the determined message delivery time to the user via the selected communication channel.

2. The method of claim 1, wherein determining the mat processing metric is also based on a number of yoga sessions associated with a user.

3. The method of claim 2, wherein the number of yoga sessions is entered by the user.

4. The method of claim 2, wherein the number of yoga sessions is entered by a facilitator of a mat processing device.

5. The method of claim 2, wherein the number of yoga sessions is determined by a mat processing device.

6. The method of claim 1, wherein dynamically generating the message content is also based on the data associated with the user.

7. The method of claim 1, wherein determining a message delivery time is also based on the data associated with the user.

8. An apparatus for processing mats, the apparatus comprising:
a processor;
a network interface operatively coupled to the processor; and
a memory device operatively coupled to the processor, the memory device storing instructions to cause the processor to:
determine a mat processing metric based on a recorded number of mat processings for a user;
select a communication channel based on first data associated with the user;
dynamically generate a message content based on the mat processing metric;
determine a message delivery time based on the mat processing metric; and
deliver the determined message content at the determined message delivery time to the user via the selected communication channel.

9. The apparatus of claim 8, wherein determining the mat processing metric is also based on a number of yoga sessions associated with a user.

10. The apparatus of claim 9, wherein the number of yoga sessions is entered by the user.

11. The apparatus of claim 9, wherein the number of yoga sessions is entered by a facilitator of the mat processing device.

12. The apparatus of claim 9, wherein the number of yoga sessions is determined by the mat processing device.

13. The apparatus of claim 8, wherein dynamically generating the message content is also based on the data associated with the user.

14. The apparatus of claim 8, wherein determining a message delivery time is also based on the data associated with the user.

15. A non-transitory computer readable medium storing instructions structured to cause a computing device to execute a program to:
determine a mat processing metric based on a recorded number of mat processings for a user;
select a communication channel based on first data associated with the user;
dynamically generate a message content based on the mat processing metric;
determine a message delivery time based on the mat processing metric; and
deliver the determined message content at the determined message delivery time to the user via the selected communication channel.

16. The computer readable medium of claim 15, wherein determining the mat processing metric is also based on a number of yoga sessions associated with a user.

17. The computer readable medium of claim 0, wherein the number of yoga sessions is entered by the user.

18. The computer readable medium of claim 0, wherein the number of yoga sessions is entered by a facilitator of a mat processing device.

19. The computer readable medium of claim 0, wherein the number of yoga sessions is determined by the a processing device.

20. The computer readable medium of claim 15, wherein dynamically generating the message content is also based on the data associated with the user.
